(19) United States
(12) Patent Application Publication
(10) Pub. No.: US 2011/0139704 A1
(43) Pub. Date: Jun. 16, 2011

(54) BLOOD DIALYZING APPARATUS

(75) Inventors: Jong Weon Choi, Seoul (KR); Hak Chun Kim, Seoul (KR); Jin Seok Kim, Seoul (KR); Byeong Seok Kim, Gyeonggi-do (KR); Byoung Goo Min, Gyeonggi-do (KR); Kyung Soo Lee, Gyeonggi-dO (KR); Sa Ram Lee, Gyeonggi-do (KR); Cho Hae Mun, Seoul (KR)

(73) Assignee: BHK CO., LTD., SEOUL (KR)

(21) Appl. No.: 12/992,888

(22) PCT Filed: Aug. 26, 2008
(86) PCT No.: PCT/KR08/04983

§ 371 Date: Feb. 28, 2011

(30) Foreign Application Priority Data
May 14, 2008 (KR) 10-2008-0044384

(51) Int. Cl. B01D 29/00

(52) U.S. Cl. 210/416.1

(57) ABSTRACT

A blood dialyzing apparatus includes a blood dialyzing filter for dialyzing blood by using a pressure difference between the blood and a dialysis solution, and a supplying means for supplying the blood and the dialysis solution to the blood dialyzing filter in order to alternately generate a state where a blood pressure is higher than a dialysis solution pressure and a state where the dialysis solution pressure is higher than the blood pressure. The blood dialyzing apparatus dialyzes a large volume of blood in a short period of time without increasing the size of the blood dialyzing filter and simply controls the volume of the dialyzed blood by adjusting the supply pressures of the blood and the dialysis solution.

### TECHNICAL FIELD

The present invention relates to a blood dialyzing apparatus in which waste materials in blood can be removed through a membrane located between flowing blood and a dialysis solution, and more particularly, to a blood dialyzing apparatus which is constructed to enhance the efficiency of dialysis by alternately increasing and decreasing the pressure of the blood and the dialysis solution, respectively.

### BACKGROUND ART

If kidney functions entirely fail or only some parts do, electrolytes in the body become unbalanced and in addition waste materials accumulate in the blood instead of being discharged out of the body together with the urine. As a way of treating this renal failure, an extracorporeal blood circuit formed by using a blood dialyzing apparatus is broadly used. The equilibrium of the electrolyte balance has been promoted by discharging the waste materials from the blood based on the simultaneous operations of the principles of diffusion or filtration.

The blood dialyzing apparatus is normally constructed to discharge waste materials from the blood by using a blood dialyzing filter equipped with a membrane in a housing in order to move the waste materials across the membrane located between the blood compartment and the dialysis solution compartment.

There are two kinds of membranes in general, a flat sheet type and a hollow fiber type. The most widely used is the hollow fiber type which is made up of a bundle of hollow fibers installed inside the cylinder-shaped housing and is potted with resin layers on both ends. The reason is that the surface of the membrane in contact with the blood or the dialysis solution is larger and the diffusion efficiency is excellent compared to its compact volume.

The conventional blood dialyzing apparatus will be described below more in detail in conjunction with the accompanying drawings.

FIG. 1 is a schematic view illustrating the structure of a typical blood dialyzing apparatus, and FIG. 2 is a cross-sectional view of the hollow fiber dialyzing filter used in the blood dialyzing apparatus.

As illustrated in FIG. 1, the blood dialyzing apparatus generally includes a blood dialyzing filter 100 constructed to allow blood and a dialysis solution to pass therethrough in order to discharge waste materials from the blood into the dialysis solution; a pure dialysis solution tank 200 for supplying a clean dialysis solution to the blood dialyzing filter; a dialysis solution collection tank 300 for collecting the dialysis solution passed through the blood dialyzing filter 100; a balancer 400 for maintaining steady control of the supplying volume and the collecting volume of the dialysis solution by comparing the clean dialysis solution and the collected dialysis solution, both of which being collected from the blood dialyzing filter 100; a blood pump 500 for supplying the patient's blood to the blood dialyzing filter 100; and a dialysis solution pump 600 for supplying the dialysis solution from the pure dialysis solution tank 200 to the blood dialyzing filter 100.

The blood dialyzing filter 100, as shown in FIG. 2, includes a housing 110 having a hollow inner space and a hollow fiber type membrane 120 installed inside the hollow inner space of the housing 110. A blood inlet 112 and a blood outlet 114 are formed at the top and the bottom of the housing 110 respectively, and a dialysis solution inlet 116 and a dialysis solution outlet 118 are formed at the bottom side and the top side of the housing 110, respectively. The blood entering through the blood inlet 112 travels through the inside of the membrane 120 and will be discharged via the blood outlet 114; and the dialysis solution entering through the dialysis solution inlet 116 travels through the space between the membrane 120 and the housing 110, and will be discharged to the dialysis solution outlet 118.

FIG. 3 is a diagram showing changes in the pressures of the blood and the dialysis solution when the conventional blood dialyzing apparatus is used.

The blood dialyzing filter 100 configured as illustrated in FIG. 2 is constructed so that the blood and the dialysis solution flow in opposite directions, and the pressures of the blood and the dialysis solution are lowered as each of them approaches the blood outlet 114 and the dialysis solution outlet 118, respectively, since the blood pump 500 and the dialysis solution pump 600 are formed at the blood inlet 112 and the dialysis solution inlet 116, respectively.

As illustrated in FIG. 3, in the top portion of the housing 110, namely the area with the blood inlet 112 and the dialysis solution outlet 118, the blood pressure is higher than the dialysis solution pressure. In the bottom portion of the housing 110, namely the area with the blood outlet 114 and the dialysis solution inlet 116, the dialysis solution pressure is higher than the blood pressure. At this time, the blood pressure line (B) and the dialysis solution pressure line (D) form almost a straight line since the blood pump 500 and the dialysis solution pump 600 continuously supply the blood and the dialysis solution of the predetermined volume respectively.

At the point where the blood pressure is higher than the dialysis solution pressure, the water, electrolytes, and the waste materials inside the slashed area shown in FIG. 3 will be diffused across the dialysis solution compartment. At the point where the dialysis solution pressure is higher than the blood pressure, the dialysis solution inside the cross-striped area will be diffused across to the blood compartment. With continuous diffusion, the waste materials in the blood will be gradually removed from the blood and the patient can be supplied with the clean blood from which the waste materials have been removed.

### DISCLOSURE

### Technical Problem

However, in the conventional blood dialyzing apparatus configured as mentioned above, a large volume of blood cannot be dialyzed in a short period of time since the pressure drop of the blood and the dialysis solution are small and large enough pressure differences cannot be achieved. Although a large volume of blood can be dialyzed if the contacting surface of the blood with the dialysis solution is made much larger, the blood dialyzing filter needs to be much longer and a large amount of membrane needs to be used.

The present invention proposes to solve the aforementioned problems and embodiments of the present invention provide a blood dialyzing apparatus formed to efficiently dialyze a large volume of blood without increasing the size of a blood dialyzing filter.

### Technical Solution

In an exemplary embodiment of the present invention, the blood dialyzing apparatus includes a blood dialyzing filter for dialyzing blood by using a pressure difference between the blood and a dialysis solution, which flow inside the blood dialyzing filter; and a supplying means for supplying the blood and the dialysis solution to the blood dialyzing filter in order to alternately generate a state where a blood pressure is higher than a dialysis solution pressure and a state where the dialysis solution pressure is higher than the blood pressure.

The supplying means may periodically change the blood pressure and the dialysis solution pressure which are supplied to the blood dialyzing filter.

The supplying means is constructed to have a phase difference of 135 degrees or 225 degrees between the blood pulsation waveform and the dialysis solution pulsation waveform.

The blood dialyzing filter is constructed to allow the blood and the dialysis solution to flow in opposite directions.

### Advantageous Effects

The blood dialyzing apparatus has advantages of dialyzing a large volume of blood in a short period of time without increasing the size of the blood dialyzing filter and offering simple control of the volume of the dialyzed blood by adjusting the supply pressures of the blood and the dialysis solution.

### DESCRIPTION OF DRAWINGS

FIG. 1 is a schematic view illustrating the structure of a typical blood dialyzing apparatus.

FIG. 2 is a cross-sectional view of a hollow fiber dialyzing filter used in the blood dialyzing apparatus.

FIG. 3 is a diagram showing changes in the blood pressure and the dialysis solution pressure when the conventional blood dialyzing apparatus is used.

FIG. 4 is a diagram showing a blood supply pressure and a dialysis solution supply pressure when a blood dialyzing apparatus in accordance with the present invention is used.

FIG. 5 is a schematic view illustrating an embodiment of the blood dialyzing apparatus in accordance with the present invention.

FIG. 6 is a schematic view illustrating an embodiment of a supply means applied to the blood dialyzing apparatus in accordance with the present invention.

### DESCRIPTION OF MAJOR REFERENCE NUMBERS

| | |
|---|---|
| 100: blood dialyzing filter | 110: housing |
| 112: blood inlet | 114: blood outlet |
| 116: dialysis solution inlet | |
| 118: dialysis solution outlet | |
| 120: membrane | 200: pure dialysis solution tank |
| 300: dialysis solution collection tank | |
| 400: balancer | 500: blood pump |
| 600: dialysis solution pump | |
| 700: double acting pump | |

### BEST MODEL

Embodiments of the blood dialyzing apparatus in accordance with the present invention will be described in detail in conjunction with the accompanying drawings.

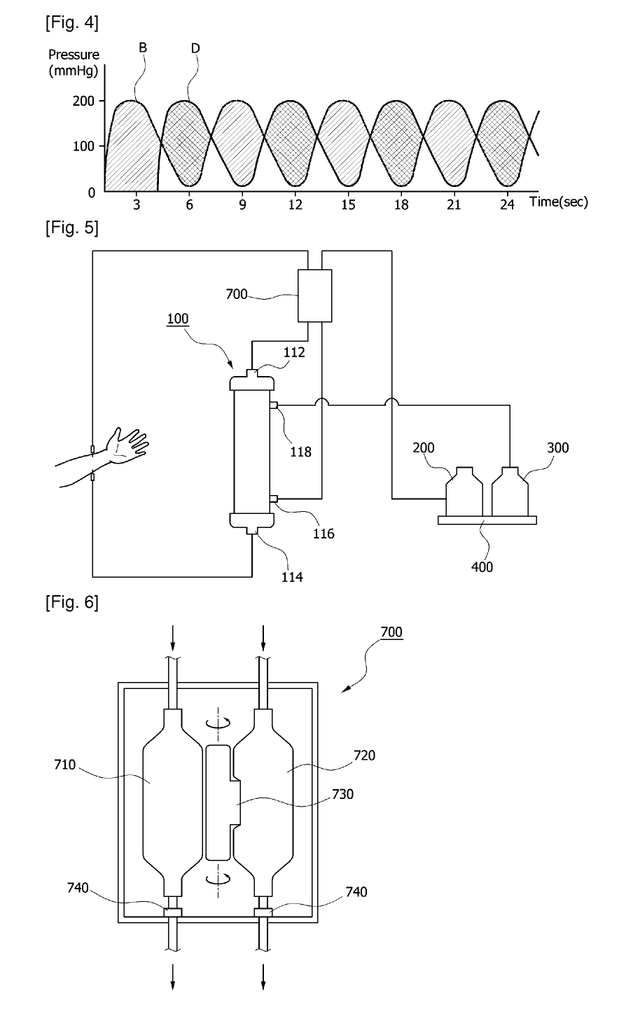

FIG. 4 is a diagram showing a blood supply pressure and a dialysis solution supply pressure when a blood dialyzing apparatus in accordance with the present invention is used.

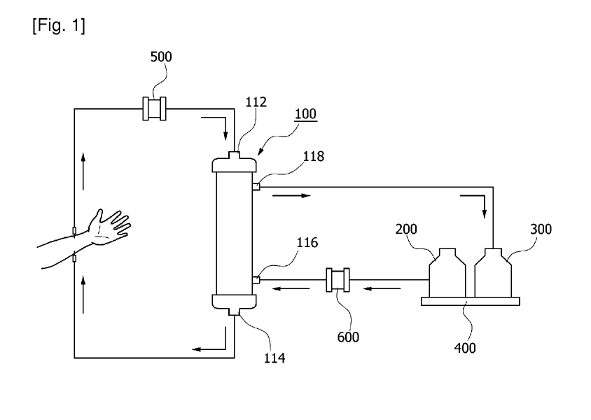

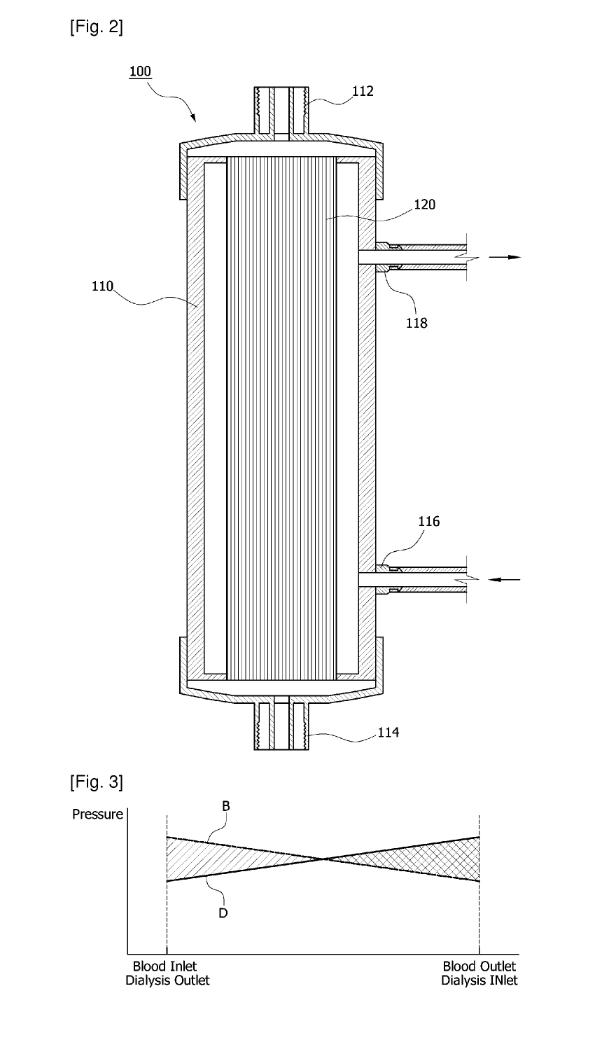

When compared to the conventional blood dialyzing apparatus having a drive system of the blood pump 500 and the dialysis solution pump 600 as shown in FIG. 1, the blood dialyzing apparatus according to the present invention is different in the supply means for supplying blood and a dialysis solution to a blood dialyzing filter 100.

In more detail, the blood pressure and the dialysis solution pressure in the blood dialyzing filter 100 are increased and decreased at regular time intervals since the blood dialyzing apparatus of the present invention provides the supply pressure of the blood and the dialysis solution with the increased or decreased pressure at regular cycles, compared to the conventional blood dialyzing apparatus wherein the blood pressure and the dialysis solution pressure in the blood dialyzing filter 100 remain stable regardless of the time since the blood and the dialysis solution are supplied to the blood dialyzing filter 100 with a regular pressure. In this context, the supply means in the blood dialyzing apparatus of the present invention alternately changes the supply pressures of the blood and the dialysis solution in order to alternately increase the blood pressure and the dialysis solution pressure in the blood dialyzing filter 100, so that the blood pressure line (B) and the dialysis solution pressure line (D) have opposite phases.

If the dialysis solution pressure is lowered when the blood pressure is increased, the pressure difference between the blood pressure and the dialysis solution pressure becomes much larger compared to the diagram in FIG. 3, and the water and the waste materials in the blood will be diffused into the dialysis solution much faster and in a large amount. And vice versa, if the blood pressure is lowered when the dialysis solution pressure is increased, the pressure difference between the dialysis solution pressure and the blood pressure becomes much larger than that of the diagram in FIG. 3, and a much larger amount of the dialysis solution will be diffused into the blood at a much faster rate.

In FIGS. 3 and 4, if the area where the blood pressure is higher than the dialysis solution pressure (slashed area), is compared with the area where the dialysis solution pressure is higher than the blood pressure (cross-striped area), it is understood that in the present invention the phenomenon of diffusing the water, electrolytes and waste materials from the blood into the dialysis solution and the phenomenon of diffusing the dialysis solution into the blood will happen faster and more efficiently than in the case of FIG. 4. With the blood dialyzing apparatus of the present invention, a large volume of blood can be dialyzed much faster by increasing the pressure difference between the blood and the dialysis solution in the blood dialyzing filter 100 without changing the size nor the configuration of the blood dialyzing filter 100.

When the blood pressure line and the dialysis solution pressure line make a perfect sine curve, the dialyzing efficiency can be maximized to the utmost by increasing the area where the blood pressure is higher than the dialysis solution pressure (slashed area) and the area where the dialysis solution pressure is higher than the blood pressure (cross-striped area) after making the phase difference be 180 degrees. However, if the blood and the dialysis solution are subject to pressure in the actual situation, the pressure line sharply increases when the blood and the dialysis solution are subject to pressure and the pressure line smoothly decreases when the pressure on the blood and the dialysis solution is released. Consequently, a diagram skewed a little in one direction will appear as shown in FIG. 4.

As a result, the user can properly adjust the phase difference between the two pressure lines at 180±45 degrees, in other words, in the area from 135 degrees to 225 degrees, according to the shape of the blood pressure line and the dialysis solution pressure line. Now, the reason why the phase difference is limited at 180±45 degrees is that the area where the blood pressure is higher than the dialysis solution pressure (slashed area) and the area where the dialysis solution pressure is higher than the blood pressure (cross-striped area) become smaller and the blood dialyzing efficiency will be only insignificantly increased when the phase difference of the two pressure lines is less than 135 degrees or bigger than 225 degrees.

Furthermore, in the conventional blood dialyzing apparatus, the pressure difference between the blood and the dialysis solution can be created by the natural decrease in the pressure while the blood and the dialysis solution flow inside the blood dialyzing filter 100, and the pressure difference between the blood and the dialysis solution cannot be easily increased, and as a result, there have been many problems associated with adjusting the blood dialyzing volume.

However, in the blood dialyzing apparatus of the present invention, the increasing pressure value of the blood and the dialysis solution flowing into the blood dialyzing filter 100 can be controlled by adjusting the supply means, in other words, the driving power of the blood pump 500 and the dialysis solution pump 600 and the pressure difference between the blood and the dialysis solution can be easily increased/decreased, and as a result, the blood dialyzing volume can be easily controlled.

In the blood and dialysis solution passing through the inside of the blood dialyzing filter 100, a flow pressure drop can occur to a small degree due to the friction against the inside of the blood dialyzing filter 100, and a pressure difference can arise (due to the permissible volume by the supply means) between the blood and the dialysis solution since the flow pressure drop can happen in both the blood and the dialysis solution when the blood and the dialysis solution are flowing in the same direction, for example, both the blood and the dialysis solution are flowing into the top portion and discharged out of the bottom portion of the blood dialyzing filter 100.

The blood dialyzing efficiency can be increased more if pressure differences corresponding to sizes of pressure applied by the supply means and area-specific pressure differences (the pressure difference as shown in FIG. 3) due to the flow pressure drop occur at the same time between the blood and the dialysis solution when the blood and the dialysis solution are flowing in opposite directions. This is the case, for example, when the blood is flowing into the top portion of the blood dialyzing filter 100 and is discharged out of the bottom, and the dialysis solution is flowing into the bottom of the blood dialyzing filter 100 and is discharged out of the top portion.

As a result, the blood dialyzing filter 100 can be structured so that the flow direction of the blood and the dialysis solution are in opposite directions.

FIG. 5 is a schematic view illustrating an embodiment of the blood dialyzing apparatus in accordance with the present invention, and FIG. 6 is a schematic view illustrating an embodiment of the supply means applied to the blood dialyzing apparatus in accordance with the present invention.

The supply means for supplying the blood and the dialysis solution to the blood dialyzing filter 100 includes the separately divided blood pump 500 and the dialysis solution pump 600 as shown in FIG. 1, and also includes a double acting pump 700 which alternately pressurizes the blood and the dialysis solution as shown in FIG. 5.

The double acting pump 700, as shown in FIG. 6, includes a blood sac 710 which can contain a certain amount of blood in a flow path of blood, a dialysis solution sac 720 which can contain a certain amount of dialysis solution in a flow path of dialysis solution, a pressure member 730 formed between the blood sac 710 and the dialysis solution sac 720 to alternately pressurize the blood sac 710 and the dialysis solution sac 720, and check valves 740 installed on the flow paths of blood and the dialysis solution, respectively, in order to prevent the blood and the dialysis solution from flowing backwards when the blood sac 710 and the dialysis solution sac 720 under pressure return to their original conditions.

The blood sac 710 and the dialysis sac 720 can be made of a flexible material in order to become smaller by the appliance of a pressure force from the outside, so that they supply the blood and the dialysis solution with the larger pressure to the blood dialyzing filter 100 when they are pressed by the pressure member 730, and they can also return to the original condition when the pressure by the pressure member 730 is released.

The pressure member 730 is constructed to turn around the axis located between the blood sac 710 and the dialysis solution sac 720. The pressure member 730 has a protrusive portion formed on one side thereof in order to press the blood sac 710 and the dialysis solution sac 720, and presses the blood sac 710 and the dialysis solution sac 720, respectively, once every time it rotates. As shown in FIG. 6, the pressure member 730 presses the blood sac 710 when the pressure member 730 rotates 180 degrees and presses again the dialysis solution sac 720 when it rotates 180 degrees from in the position of pressing the blood sac 710.

If the pressure means is constructed with the double acting pump 700 as shown in FIG. 6, the blood and the dialysis solution can be alternately pressed at 180 degree intervals by simply rotating the pressure member 730; the blood pressure line and the dialysis solution pressure line with the shape of the diagram in FIG. 4 can be obtained without any specific control means.

In the embodiments of the present invention, the present invention has been described with the exemplary embodiments. In the first case, the pressure means alternately increases the pressures of the blood and the dialysis solution in the blood dialyzing filter 100 by separately constructing the blood pump 500 and the dialysis solution pump 600, and in the second case, the pressures of the blood and the dialysis solution in the blood dialyzing filter 100 can be alternately increased by alternately pressing the blood sac 710 and the dialysis solution sac 720. However, the pressure means is not limited to the structure mentioned in the foregoing embodiments of the present invention and can be modified into any structures capable of alternately increasing the pressures of the blood and the dialysis solution.

While the present invention has been described in connection with the exemplary embodiments, it is not to be limited thereto but will be defined by the appended claims. It is to be understood that those skilled in the art can substitute, change or modify the embodiments in various forms without departing from the scope and spirit of the present invention.

1. A blood dialyzing apparatus, comprising:
a blood dialyzing filter dialyzing blood by using a pressure difference between the blood and a dialysis solution, which flow inside the blood dialyzing filter; and
a supplying means for supplying the blood and the dialysis solution to the blood dialyzing filter in order to alternately generate a state where a blood pressure is higher than a dialysis solution pressure and a state where the dialysis solution pressure is higher than the blood pressure.

2. The blood dialyzing apparatus according to claim 1, wherein the supplying means periodically changes the blood pressure and the dialysis solution pressure which are supplied to the blood dialyzing filter.

3. The blood dialyzing apparatus according to claim 2, wherein the supplying means is constructed to have a phase difference of 135 degrees or 225 degrees between a blood pulsation waveform and a dialysis solution pulsation waveform.

4. The blood dialyzing apparatus according to claim 1, wherein the blood dialyzing filter is constructed to allow the blood and the dialysis solution to flow in opposite directions.
